(19) United States
(12) Patent Application Publication
(10) Pub. No.: US 2026/0339545 A1
(43) Pub. Date: Oct. 29, 2026

(54) MEMORY SYSTEMS, METHODS OF OPERATING MEMORY SYSTEMS, MEMORY CONTROLLERS, AND MEMORY DEVICES

(71) Applicant: Yangtze Memory Technologies Co., Ltd., Wuhan (CN)

(72) Inventor: Yue Zhang, Wuhan (CN)

(21) Appl. No.: 19/358,073

(22) Filed: Oct. 14, 2025

(30) Foreign Application Priority Data
Apr. 24, 2025 (CN) 202510522820.5

(51) Int. Cl. G06F 3/06

(52) U.S. Cl. CPC G06F 3/0655; G06F 3/0604; G06F 3/0679

(57) ABSTRACT

An example memory system includes a memory device and a memory controller coupled to the memory device. The memory controller is configured to receive a first write request and send a first write instruction to the memory device in response to the first write request. The first write instruction includes an address of a first physical block. The first write instruction is to instruct the memory device to program a memory cell in the first physical block to write M bits of data. The first physical block passes a part of burn-in tests, and M is related to the part of the burn-in tests passed by the first physical block.

### CROSS-REFERENCE TO RELATED APPLICATIONS

The present application claims the benefit of priority to Chinese Patent Application No. 202510522820.5, filed on Apr. 24, 2025, which is hereby incorporated herein by reference in its entirety.

### FIELD OF TECHNOLOGY

The present disclosure relates to the field of semiconductor chip technologies, and in particular to memory systems, methods of operating a memory systems, memory controllers, and memory devices.

### BACKGROUND

In a memory system, a number of valid blocks (NVB) of a memory device affects the over provisioning (OP) of the memory system. The size of the over provisioning directly affects the performance of garbage collection (GC) and the write amplification (WAF) problem. When the over provisioning is small, the performance of garbage collection is reduced, and the write amplification is increased.

### BRIEF DESCRIPTION OF THE DRAWINGS

In order to more clearly illustrate the technical solutions in the present disclosure, the accompanying drawings that need to be used in some examples of the present disclosure are briefly described below, and obviously, the accompanying drawings in the following description are merely accompanying drawings of some examples of the present disclosure, and other accompanying drawings may be obtained by those skilled in the art based on these accompanying drawings. In addition, the accompanying drawings in the following description may be regarded as schematic diagrams, and do not limit the actual size of the product, the actual flow of the method, the actual timing of the signal, and the like in some examples of the present disclosure.

FIG. 1 is a schematic structural diagram of a memory system according to some examples of the present disclosure.

FIG. 2 is a schematic structural diagram of a physical block according to some examples of the present disclosure.

FIG. 3 is a schematic partial cross-sectional view of a memory string according to some examples of the present disclosure.

FIG. 4 is a schematic diagram of a threshold voltage distribution interval of a memory cell in each memory mode according to some examples of the present disclosure.

FIG. 5 is a schematic flowchart of a method of operating a memory system according to some examples of the present disclosure.

FIG. 6 is a first schematic diagram of interactions between a memory controller and a memory device according to some examples of the present disclosure.

FIG. 7 is a second schematic diagram of interactions between a memory controller and a memory device according to some examples of the present disclosure.

FIG. 8 is a third schematic diagram of interactions between a memory controller and a memory device according to some examples of the present disclosure.

FIG. 9 is a schematic flowchart of a memory controller responding to a write request according to some examples of the present disclosure.

FIG. 10 is a schematic structural diagram of a memory controller according to some examples of the present disclosure.

FIG. 11 is a schematic structural diagram of a memory device according to some examples of the present disclosure.

FIG. 12 is a schematic structural diagram of a connection between a peripheral circuit and a memory array according to some examples of the present disclosure.

Reference numeral: 100, memory system; 110, memory controller; 120, memory device; 200, physical block; 210, memory string; 211, top select gate; 212, memory cell; 213, bottom select gate; 310, semiconductor layer; 320, stack structure; 321, gate conductive layer; 322, dielectric layer; 410, bit line; 420, source line; 430, top select line; 440, word line; 450, bottom select line; 510, processor; 520, first interface circuit; 530, second interface circuit; 610, peripheral circuit; 611, control logic circuit; 612, I/O interface; 613, voltage generator; 614, column decoder; 615, row decoder; 616, page buffer; 617, data bus; 618, register; 620, memory array.

### DETAILED DESCRIPTION

The technical solutions in some examples of the present disclosure are clearly and completely described below with reference to the accompanying drawings, and obviously, the described examples are only some of the examples of the present disclosure, and are not all examples. All other examples obtained by those skilled in the art based on the examples provided in the present disclosure fall within the protection scope of the present disclosure.

Unless otherwise required by the context, throughout the specification and claims, the term “includes” is interpreted as open and inclusive, meaning “including, but not limited to” or “including, but not limited”. In the description of the specification, the terms “one example,” “some examples,” and the like are intended to indicate that the example or a particular feature, structure, material, or characteristic associated with the example is included in at least one example of the present disclosure. The schematic representation of the above terms does not necessarily refer to the same example. Further, the particular feature, structure, material, or characteristic described may be included in any suitable manner in any one or more examples.

The terms “first” and “second” are used for descriptive purposes only and are not to be construed as indicating or implying relative importance or implicitly indicating the number of indicated technical features. Thus, features defined by “first”, “second” may explicitly or implicitly include one or more of the features. In the description of the examples of the present disclosure, unless otherwise indicated, the meaning of “a plurality of” is two or more.

In describing some examples, “coupled to,” and “connected to,” and their derivatives, may be used. For example, the term “connected to” may be used in describing some examples to indicate that two or more components are in direct physical contact or electrical contact with each other. As another example, the term “coupled to” may be used in describing some examples to indicate that two or more components in direct physical contact or electrical contact with each other. However, the term “coupled to” may also mean that two or more components are not in direct contact with each other but still cooperate or interact with each other. The examples disclosed herein are not necessarily limited to the disclosure herein.

The use of “adapted to” or “configured to” herein means an open and inclusive language that does not exclude devices adapted to or configured to perform additional tasks or operations.

In addition, the use of “based on” means open and inclusive, since in practice, the process, operation, calculation, or other action “based on” one or more of the conditions or values may be based on additional conditions or beyond the values.

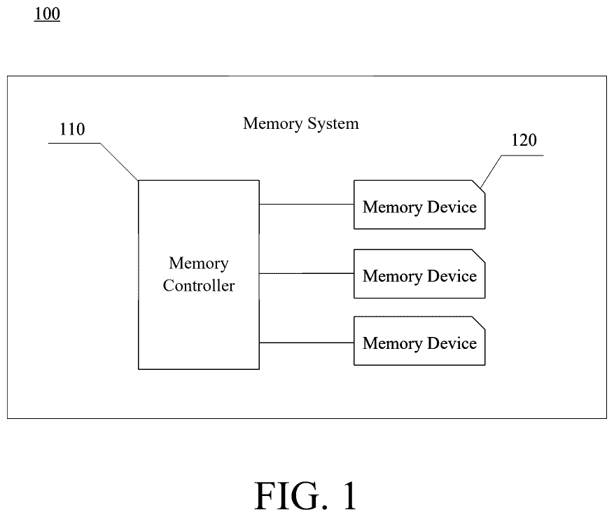

Some examples of the present disclosure provide a memory system. As shown in FIG. 1, the memory system 100 includes a memory controller 110 and a memory device 120 coupled to the memory device 120. In some examples, the memory controller 110 may be configured to manage data stored in the memory device 120 and communicate with an external device, such as a host. In some examples, the memory controller 110 may also be configured to control operations of the memory device 120, such as read, erase, and program operations. In some examples, the memory controller 110 may also be configured to manage various functions regarding data stored in or to be stored in the memory device 120, including at least one of bad block management, garbage collection, logical-to-physical address translation, wear leveling. In some examples, the memory controller 110 is further configured to process error correction code (ECC) regarding data read from or written to the memory device 120.

Of course, memory controller 110 may also perform any other suitable functions. For example, the memory controller 110 formats the memory device 120. For example, the memory controller 110 may also communicate with an external device through at least one of various interface protocols. In some examples, the interface protocol may include at least one of a universal serial bus (USB) protocol, a multi media card (MMC) protocol, a peripheral component interconnect (PCI) protocol, a PCI express (PCI-E) protocol, an advanced technology attachment (ATA) protocol, a serial ATA protocol, a parallel ATA protocol, a small computer system interface (SCSI) protocol, an enhanced small disk interface (ESDI) protocol, and an integrated drive electronics (IDE) protocol.

In some examples, the memory system 100 may be packburn-in into different types of electronic products. For example, the memory system 100 includes a controller and a memory device 120, and the memory system 100 may be integrated into a memory card. The memory card includes any of a personal computer memory card (PCMCIA card), a compact flash (CF) card, a smart media (SM) card, a memory stick, a multi-media card (MMC), and a secure digital (SD) card. For example, the memory system 100 includes a controller and a plurality of memory devices 120, and the memory system 100 is integrated into solid state drive (SSD).

In some examples, the memory system 100 may be applied to different types of electronic devices, for example, any electronic device capable of storing data, such as a mobile phone (for example, a cellphone), a desktop computer, a tablet computer, a notebook computer, a server, a vehicle-mounted device, a game console, a printer, a positioning device, a wearable device, a smart sensor, a mobile power supply, a virtual reality (VR) device, an augmented reality (AR) device, and a server.

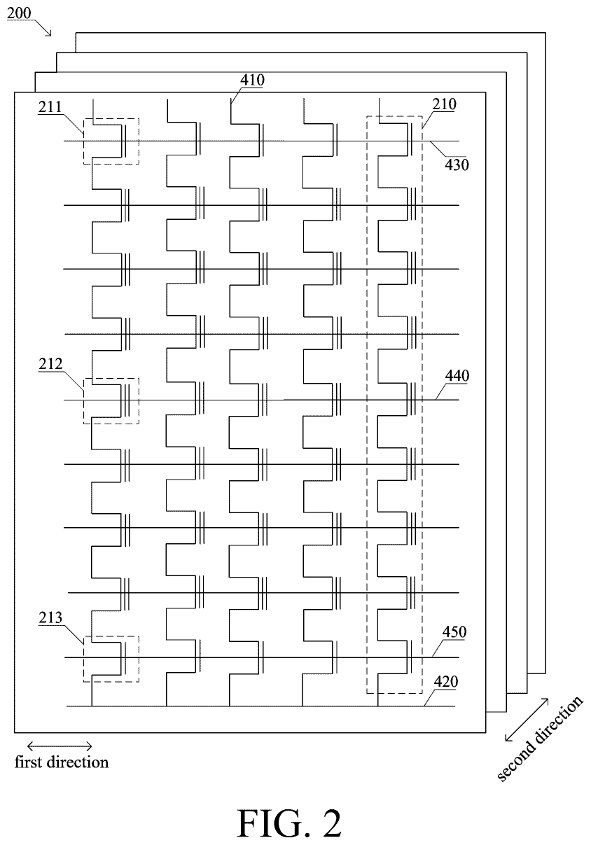

In some examples, the memory device 120 may include a plurality of physical blocks. As shown in FIG. 2, each physical block 200 may include a plurality of memory strings 210, one end of the memory string 210 is coupled to a bit line (BL) 410, and the other end of the memory string 210 is coupled to a source line (SL) 420. Each memory string 210 may include a top select gate (TSG) 211, a plurality of memory cells 212, and a bottom select gate (BSG) 213 stacked in series.

The memory strings 210 may be arranged in a row along a first direction, and the plurality of rows of memory strings 210 may be arranged into a physical block 200 along a second direction perpendicular to the first direction. In some examples, in the same row of memory strings 210, the gate of the top select gate 211 of each memory string 210 may be coupled to the same top select line 430, in some examples, the gates of the top select gates 211 of some rows of memory strings 210 in the plurality of rows of memory strings 210 may be coupled to the same top select line 430, and the memory strings 210 whose gates of the top select gates 211 are coupled to the same top select line 430 may constitute memory slices. The gate of the bottom select gate 213 in each memory string 210 may be coupled to the same bottom select line 450. In some examples, the selected memory string 210 may be activated during a read operation, a program operation, and an erase operation by the top select line 430 and the bottom select line 450.

Each memory string 210 is coupled to the peripheral circuit 610 through a corresponding bit line 410, e.g., the drain of the top select gate 211 in the memory string 210 is coupled to the bit line 410. In order to reduce the number of bit lines 410, memory strings 210 in any one memory slice and memory strings 210 of corresponding locations in other memory slices may be coupled to the same bit line 410.

For the plurality of memory strings 210 in the physical block 200, the control gates of the memory cells 212 in any one memory string 210 and the control gates of the memory cells 212 in corresponding locations in the other memory strings 210 may be coupled to the same word line 440. A source of the bottom select gate 213 in the memory string 210 may be coupled to a source line 420 (or a common source line (CSL)).

It should be noted that the drawings of the present disclosure only illustrate the structure of the physical block 200 of some examples, but in practice, the structure of the physical block 200 may also be in other manners.

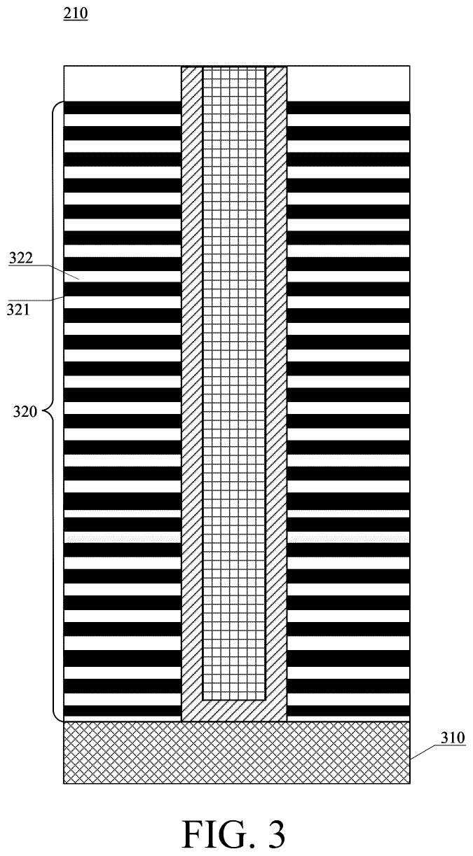

FIG. 3 shows a partial cross-sectional view of a possible memory string 210. The memory string 210 may vertically extend over the semiconductor layer 310. The semiconductor layer 310 may include silicon (e.g., monocrystalline silicon), silicon germanium (SiGe), gallium arsenide (GaAs), germanium (Ge), silicon-on-insulator (SOI), germanium-on-insulator (GOI), or any other suitable material.

The memory string 210 may include a channel structure throughout the stack structure 320, which may include alternating gate conductive layers 321 and dielectric layers 322. The number of gate conductive layers 321 and dielectric layers 322 in the stack structure 320 is correlated to the number of memory cells 212 in the memory string 210.

The gate conductive layer 321 may include a conductive material including, but not limited to, tungsten (W), cobalt (Co), copper (Cu), aluminum (Al), polysilicon, doped silicon, silicide, or any combination thereof. In some examples, each of the gate conductive layers 321 includes a metal layer, such as a tungsten layer. In some examples, each of the gate conductive layers 321 includes a doped polysilicon layer. Each of the gate conductive layers 321 may include a control gate surrounding the memory cell 212, and the gate conductive layer 321 at the top of the stack structure 320 may extend laterally and be coupled to a top select line (TSL) 430, the gate conductive layer 321 at the bottom of the stack structure 320 may extend laterally and be coupled to a bottom select line (BSL) 450, or the gate conductive layer 321 between the top select line 430 and the bottom select line 450 may extend laterally and be coupled to a word line (WL) 440.

It should be understood that although not shown in FIG. 3, additional features of the memory string 210 may be formed including, but not limited to, gate line slot/source contacts, local contacts, interconnect layers, and the like.

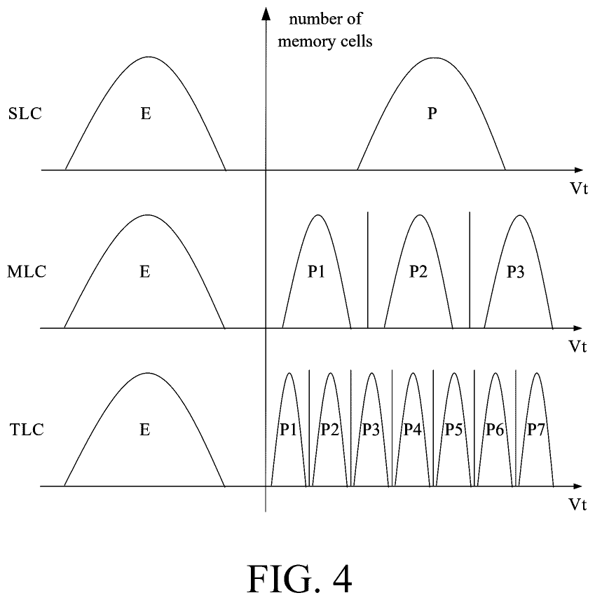

In some examples, the plurality of memory cells 212 stacked in series in the memory string 210 may be device capable of storing charges, such as floating gate transistors or charge trap type field effect transistors, and the like. In some examples, the memory mode of the memory cell 212 may include a single-level cell (SLC) and a multi-level cell (MLC). As shown in FIG. 4, the memory cell 212 employing the single-level cell memory mode may store one bit and may have two states; that is, one erase (E) state and one program (P) state. The memory cell 212 employing the multi-level cell memory mode may store two bits (e.g., 2 bit) or more than two bits and may have four or more states. In some examples, the memory cell 212 may employ a multi-level cell memory mode, each memory cell 212 may store two bits and may have four states; that is, three program states (e.g., P1 state, P2 state, and P3 state in FIG. 4) and one erase state (e.g., E state in FIG. 4). In some examples, the memory cell 212 may also employ a triple-level cell (TLC) memory mode, each memory cell 212 may store three bits and may have eight states; that is, seven program states (e.g., P1 state, P2 state, P3state, P4 state, P5 state, P6 state, and P7 state in FIG. 4) and one erase state (e.g., E state in FIG. 4). In some examples, each state of the memory cell 212 has a threshold voltage distribution interval in one-to-one correspondence.

In some examples, the number of valid blocks of the memory device 120 affects the memory space of the memory system 100, wherein the memory space may be divided into a user space and an over provisioning. In the memory space of the memory system 100, the user space is a space for storing user data, the over provisioning is a space other than the user space, and the over provisioning may be used for garbage collection, wear leveling, and bad block replacement, and the like.

The size of the over provisioning directly affects the performance of garbage collection and the write amplification problem, in some examples, when garbage collection is performed, the memory controller 110 may use the valid physical blocks in the over provisioning as the temporary buffer, and if the over provisioning is large, the garbage collection may be performed on more physical blocks 200 in batches, thereby improving the efficiency of the garbage collection. Moreover, since the larger over provisioning allows the memory controller 110 to combine more valid data during garbage collection, the migration times of invalid data can be reduced, thereby reducing the write amplification. Conversely, if the over provisioning is small, the performance of the garbage collection is reduced, the write amplification is increased, thereby affecting the performance and the lifetime of the memory system 100.

To improve the size of the over provisioning, the memory controller 110 in the memory system 100 according to some examples of the present disclosure is configured to: receive and in response to a first write request, send a first write instruction to the memory device 120, wherein the first write instruction includes an address of a first physical block. The first write instruction instructs the memory device 120 to program a memory cell 212 in the first physical block to write M bits of data, wherein the first physical block is a physical block 200 that passes a part of burn-in tests, and M is related to the part of burn-in tests passed by the first physical block.

A burn-in test screens out a physical block 200 in which a potential defect may exist in an early stage of the life cycle of the memory device 120 by performing a high pressure test on the memory device 120, simulating a long term use, and the like, and the physical block 200 that fails the burn-in test may be referred to as a burn-in bad block (BIBB). After performing the burn-in test on the memory device 120, the burn-in test results of the memory device 120 may be obtained. The burn-in test results may include a burn-in bad block table (BIBBT).

In some examples, the burn-in test includes a first memory mode test for testing whether the memory cell 212 in the physical block 200 can successfully store M bits of data and a second memory mode test for testing whether the memory cell 212 in the physical block 200 can successfully store N bits of data, wherein M is different from N. In some examples of the present disclosure, the first physical block is a physical block 200 that passes the first memory mode test but fails the second memory mode test.

In some examples of the present disclosure, the memory controller 110 may further subdivide the burn-in bad block according to the burn-in bad block table, for example, the first physical block is subdivided in the burn-in bad block. The first physical block passes the first memory mode test, so the memory controller 110 may send a first write instruction to instruct the memory device 120 to program the memory cell 212 in the first physical block to write the M bits of data in subsequent use. That is, in some examples of the present disclosure, the subdivided physical block 200 that passes the part of burn-in tests (for example, the first physical block that passes the first memory mode test) may be used in a burn-in bad block that would not otherwise be used, to increase the number of valid blocks. The increase in the number of valid blocks increases the memory space of the memory system 100, thereby increasing the over provisioning, and improving the performance and lifetime of the memory system 100.

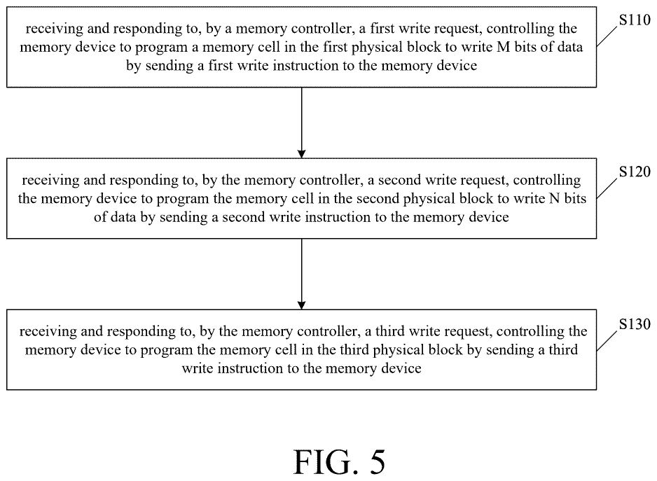

Some examples of the present disclosure further provide a method of operating a memory system, as shown in FIG. 5, the method includes S110-S130, as follows:
S110: receiving and responding to, by a memory controller, a first write request, controlling the memory device to program a memory cell in the first physical block to write M bits of data by sending a first write instruction to the memory device.

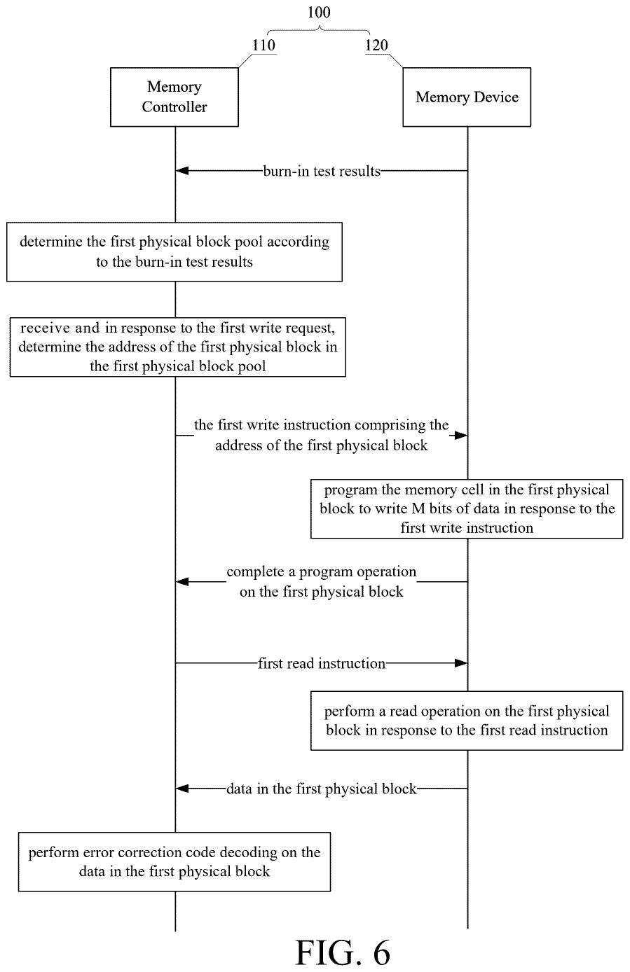

The first write instruction includes an address of the first physical block, and the first physical block belongs to the first physical block pool. In some examples, the memory controller 110 may determine the first physical block pool according to burn-in test results (e.g., a burn-in bad block table) of the memory device 120. As shown in FIG. 6, the burn-in test results may be stored in the memory device 120, and when the memory device 120 and the memory controller 110 form the memory system 100, the memory controller 110 may obtain burn-in test results from the memory device 120, and determine the first physical block pool according to the burn-in test results.

In some examples, according to the burn-in bad block table, the memory controller 110 may determine a physical block 200 that passes the first memory mode test but fails the second memory mode test to be a physical block 200 in the first physical block pool, thereby determining the first physical block pool. The physical block 200 that passes the first memory mode test can successfully store M bits of data using the first memory mode, and the physical block 200 that passes the second memory mode test can successfully store N bits of data using the second memory mode, where M is different from N.

In some examples, the first memory mode is an SLC memory mode, and the second memory mode is a TLC memory mode. With continued reference to FIG. 6, that is, the memory controller 110 may determine the address of the first physical block in the first physical block pool in response to the first write request, and send the first write instruction including the address of the first physical block to the memory device 120. The memory device 120 may program the memory cell 212 in the first physical block to write M bits of data in response to the first write instruction, e.g., write one bit of data (e.g., M=1).

Although the first physical block passes the first memory mode test, it is still different from the normal good block (e.g., the physical block 200 passes all burn-in tests). Therefore, the memory system 100 needs to perform more verification operations to ensure the accuracy of programming the memory cell 212 in the first physical block to write the M bits of data. With continued reference to FIG. 6, in some examples, the memory controller 110 may send the first read instruction to the memory device 120 in response to the memory device 120 completing a program operation on the first physical block. The memory device 120 may perform a read operation on the first physical block in response to the first read instruction. The memory controller 110 may perform error correction code decoding on the data in the first physical block read by the memory device 120 to further verify the accuracy of programming the write data to the memory cell 212 in the first physical block.

In some examples, if the memory controller 110 fails to perform error correction code decoding on the data in the first physical block, the memory controller 110 may re-determine the address of one physical block 200 in the first physical block pool and re-send the write request to the memory device 120. The re-sent write request includes an address of the re-determined physical block 200 to control the memory device 120 to program the memory cell 212 in the physical block 200 to write one bit of data.
S120: receiving and responding to, by the memory controller, a second write request, controlling the memory device to program the memory cell in the second physical block to write N bits of data by sending a second write instruction to the memory device.

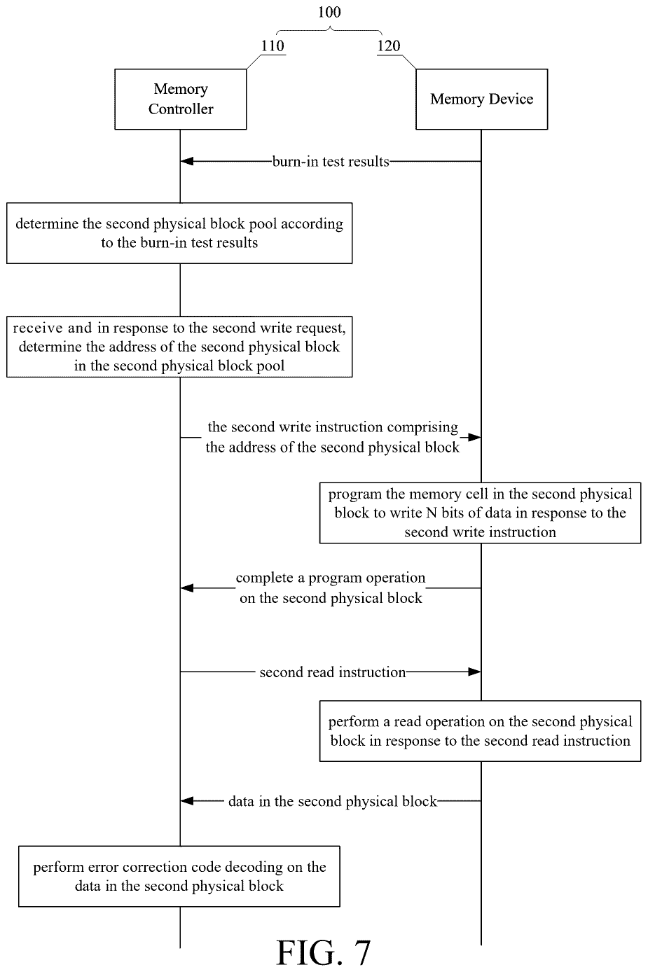

The second write instruction includes an address of the second physical block, and the second physical block belongs to the second physical block pool. As shown in FIG. 7, in some examples, the memory controller 110 may further determine the second physical block pool according to the burn-in test results (that is, a burn-in bad block table) obtained from the memory device 120.

In some examples, according to the burn-in bad block table, the memory controller 110 may determine a physical block 200 that passes the second memory mode test but fails the first memory mode test to be a physical block 200 in the second physical block pool, thereby determining the second physical block pool. As described above, the physical block 200 that passes the first memory mode test can successfully store M bits of data using the first memory mode, and the physical block 200 that passes the second memory mode test can successfully store N bits of data using the second memory mode, where M is different from N.

In some examples, the first memory mode is an SLC memory mode, and the second memory mode is a TLC memory mode. With continued reference to FIG. 7, that is, the memory controller 110 may determine the address of the second physical block in the second physical block pool in response to the second write request, and send the second write instruction including the address of the second physical block to the memory device 120. The memory device 120 may program the memory cell 212 in the second physical block to write N bits of data in response to the second write instruction, e.g., write three bits of data (e.g., N=3).

Although the second physical block passes the second memory mode test, it is still different from the normal good block (e.g., the physical block 200 passes all burn-in tests). Therefore, the memory system 100 still needs to perform more verification operations to ensure the accuracy of programming the memory cell 212 in the second physical block to write the N bits of data. With continued reference to FIG. 7, in some examples, the memory controller 110 may send the second read instruction to the memory device 120 in response to the memory device 120 completing a program operation on the second physical block. The memory device 120 may perform a read operation on the second physical block in response to the second read instruction. The memory controller 110 may perform error correction code decoding on the data in the second physical block read by the memory device 120 to further verify the accuracy of programming the write data to the memory cell 212 in the second physical block.

Likewise, in some examples, if the memory controller 110 fails to perform error correction code decoding on the data in the second physical block, the memory controller 110 may re-determine the address of one physical block 200 in the second physical block pool and re-send the write request to the memory device 120. The re-sent write request includes an address of the re-determined physical block 200 to control the memory device 120 to program the memory cell 212 in the physical block 200 to write three bits of data.
S130: receiving and responding to, by the memory controller, a third write request, controlling the memory device to program the memory cell in the third physical block by sending a third write instruction to the memory device.

The third write instruction includes an address of the third physical block, and the third physical block belongs to the third physical block pool. In some examples, the physical block 200 in the third physical block pool is not a factory bad block and passes all burn-in tests (e.g., not present in a burn-in bad block table). The factory bad block is different from the burn-in bad block. The burn-in bad block is a physical block 200 with a certain defect exposed by the memory device 120 in the burn-in test, and the factory bad block is an invalid block directly generated in the manufacturing process of the memory device 120 due to physical defects (for example, wafer impurity and etching deviation, and the like), and the factory bad block is detected and marked in the factory bad block table at the initial test stage after the production of the memory device 120 is completed. In some examples, the factory bad block and the burn-in bad block are marked together in the same bad block table; that is, the burn-in bad block table and the factory bad block table are in one table and are not separated.

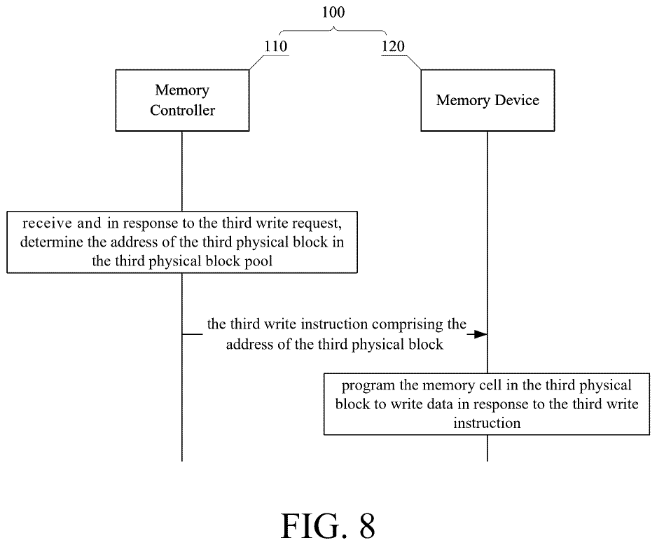

As shown in FIG. 8, in some examples, the memory controller 110 may determine the address of the third physical block in the third physical block pool in response to the third write request, and send a third write instruction including the address of the third physical block to the memory device 120. The memory device 120 may program the memory cell 212 in the third physical block to write data in response to the third write instruction.

Since the third physical block is a normal good block (e.g., the physical block 200 that passes all burn-in tests), the memory cell 212 in the third physical block may support storing one or more bits of data. In some examples, the memory device 120 may program the memory cell 212 in the third physical block to write one bit of data for the first time. After erasing the third physical block, the memory device 120 may program the memory cell 212 in the third physical block to write the three bits of data for the second time. Moreover, the memory system 100 does not need to perform more verification operations, and may also ensure the accuracy of programming the memory cell 212 in the third physical block to write data.

In some examples, in addition to the physical block 200 (for example, the first physical block and the second physical block) that passes the part of burn-in tests, the physical block 200 in the burn-in bad block table further includes an entire physical block that fails all burn-in tests. In addition, as the memory system 100 is used, some of the otherwise normal physical blocks 200 may not work properly due to wear, resulting in the generation of grown bad blocks.

In some examples, the memory controller 110 also marks a physical block that fails all burn-in tests in the burn-in test, a factory bad block, and a growth bad block as bad blocks, and creates a bad block table (BBT). In subsequent stages of use, the memory controller 110 may skip or replace these physical blocks 200 marked as bad blocks according to the bad block table to avoid using these physical blocks 200 marked as bad blocks.

It should be understood that the first write request, the second write request, and the third write request described above are intended to distinguish the write requests in S110-S130 as different write requests. In some examples, there is no specific order of execution for S110 to S130.

Since the memory system 100 needs to perform more verification operations on the first physical block and the second physical block, etc., which pass the part of burn-in tests, to ensure the accuracy of programming, thus both the time the memory device 120 spends on programming the first physical block and the time the memory device 120 spends on programming the second physical block are greater than the time the memory device 120 spends on programming the third physical block.

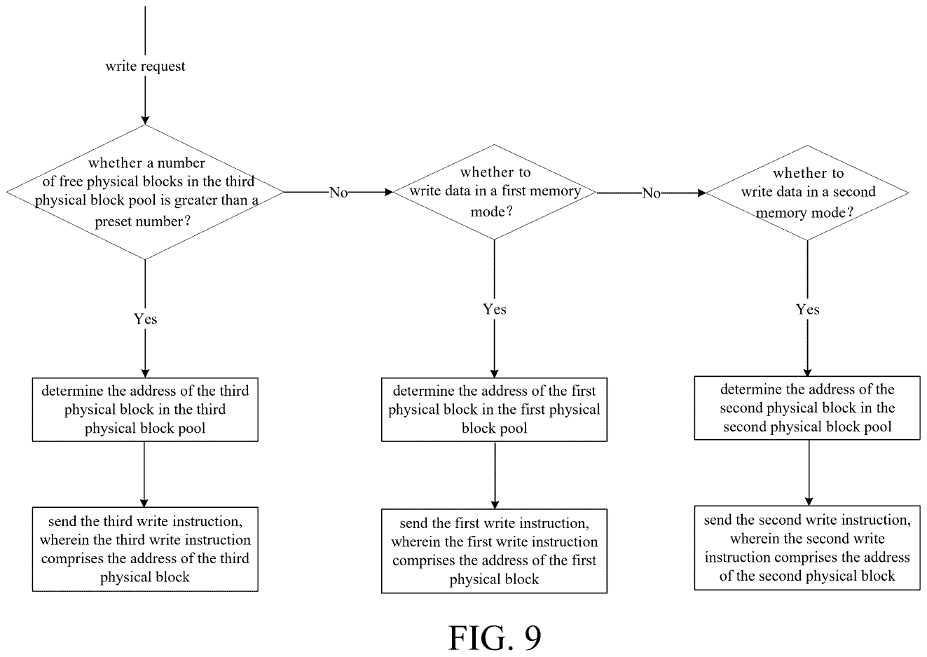

In other examples, in order to ensure that the data writing speeds of the memory system 100 in the early stage of use, there is a specific order of execution for S110 to S130. In some examples, as shown in FIG. 9, when a number of free physical blocks 200 in the third physical block pool is greater than a preset number, the memory controller 110 sends a third write instruction to the memory device 120 in response to a write request. In some examples, the preset number is equal to zero.

That is, when the number of free physical blocks 200 in the third physical block pool is large, the memory controller 110 determines the address of the third physical block in the third physical block pool in response to the write request, and sends the third write instruction to the memory device 120, wherein the third write instruction includes the address of the third physical block.

With continued reference to FIG. 9, in response to the write request, when the number of free physical blocks 200 in the third physical block pool is less than or equal to the preset number, the memory controller 110 sends the first write instruction to the memory device 120 in response to writing the data in the first memory mode, and sends the second write instruction to the memory device 120 in response to writing the data in the second memory mode.

That is, only when the number of free physical blocks 200 in the third physical block pool is small, the memory controller 110 determines the address of the first physical block in the first physical block pool according to the memory mode, and sends the first write instruction to the memory device 120, wherein the first write instruction includes the address of the first physical block; or determines the address of the second physical block in the second physical block pool, and sends the second write instruction to the memory device 120, wherein the second write instruction includes the address of the second physical block. That is, S130 is performed before S110 and S120.

In the memory system 100 according to some examples of the present disclosure, the memory device 120 may store a burn-in bad block table, and after obtaining the burn-in bad block table, the memory controller 110 may further subdivide the burn-in bad block according to the burn-in bad block table to determine the first physical block pool and the second physical block pool. When the number of free physical blocks 200 in the third physical block pool is small, the memory controller 110 may use the physical blocks 200 in the first physical block pool (e.g., select the first physical block) or the physical blocks 200 in the second physical block pool (e.g., select the second physical block) to store the data according to the memory mode. Thus, the subdivided physical block 200 that passes the part of burn-in tests may be used in a burn-in bad block that would not otherwise be used, to increase the number of valid blocks. The increase in the number of valid blocks increases the memory space of the memory system 100, thereby increasing the over provisioning, and improving the performance and lifetime of the memory system 100.

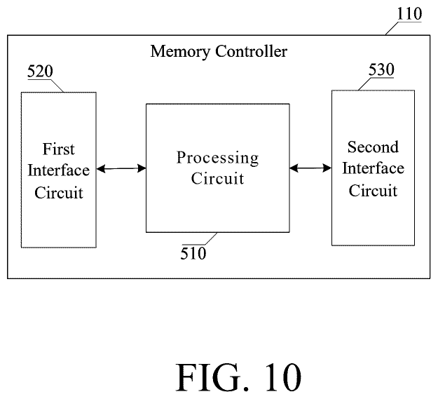

Some examples of the present disclosure further provide a memory controller. As shown in FIG. 10, the memory controller 110 includes a processing circuit 510, a first interface circuit 520, and a second interface circuit 530, and the first interface circuit 520 and the second interface circuit 530 are respectively coupled to the processing circuit. The first interface circuit 520 is configured to receive a first write request, and the second interface circuit 530 is configured to be coupled to the memory device 120. The processing circuit 510 is configured to: receive a first write request through the first interface circuit 520; and in response to the first write request, send a first write instruction to a memory device 120 through the second interface circuit 530. The first write instruction includes an address of a first physical block., and the first write instruction instructs the memory device 120 to program a memory cell 212 in the first physical block to write M bits of data. The first physical block is a physical block 200 that passes a part of burn-in tests, and M is related to the part of burn-in tests passed by the first physical block.

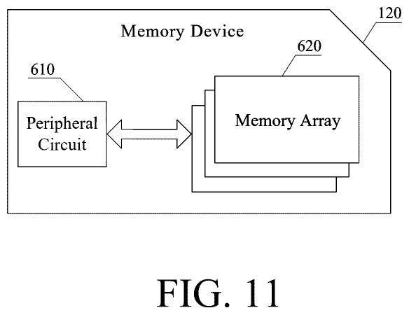

Some examples of the present disclosure provide a memory device. As shown in FIG. 11, the memory device 120 may include a memory array 620 and a peripheral circuit 610, and the memory array 620 is coupled to the peripheral circuit 610. In some examples, the peripheral circuit 610 and the memory array 620 may be formed separately on two wafers using different semiconductor processes. In some examples, the memory array 620 may be formed by a mature process (e.g., 22 nm, 28 nm, or any of the above processes) to ensure the stability of the stored data. The peripheral circuit 610 may be formed by an advanced process (e.g., 14 nm, 10 nm, or any of the following processes, etc.), thereby helping to improve the speed at which the memory device 120 reads/writes data. A wafer on which the memory array 620 is formed (which may be referred to as an array wafer) and a wafer on which the peripheral circuit 610 is formed (which may be referred to as a coms wafer) are bonded to each other by a bonding process, so that the peripheral circuit 610 is coupled to the memory array 620.

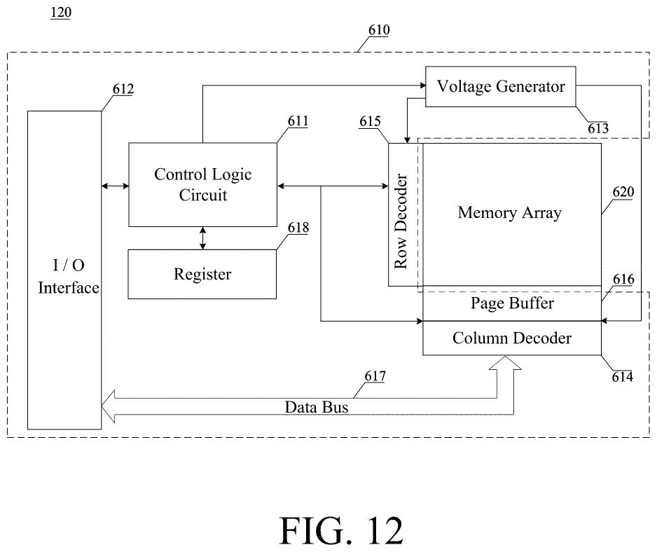

As shown in FIG. 12, in some examples, the peripheral circuit 610 includes a control logic circuit 611, an I/O interface 612, a voltage generator 613, a column decoder 614, a row decoder 615, a page buffer 616, a data bus 617, and a register 618. It should be understood that in some examples, additional circuits not shown in FIG. 12 may also be included.

Control logic circuit 611 may be coupled to the voltage generator 613, the page buffer 616, the column decoder 614, the row decoder 615, and the I/O interface 612, etc., and is configured to control operation of each peripheral circuit 610. The control logic circuit 611 may generate an operation signal in response to a command (CMD) or a control signal received by the I/O interface 612, to control the operations of the row decoder 615, the column decoder 614, the page buffer 616, and the voltage generator 613, wherein the command may be a program command, a read command, or the like.

The I/O interface 612 may be coupled to the control logic circuit 611 and act as a control buffer to buffer the received control commands and relay them to the control logic circuit 611, and buffer status information received from the control logic circuit 611 and relay the status information to the host. The I/O interface 612 may also be coupled to the page buffer 616 via a data bus 617 and act as a data I/O interface and a data buffer to buffer data and relay it to the memory array 620 or buffer or relay data from the memory array 620.

The voltage generator 613 may use an external supply voltage or an internal supply voltage to generate various voltages for performing operations such as erase, program, read, and verify on the memory array 620, for example, a program voltage Vpgm, an erase voltage Vera and a ground voltage Vss, etc., and combinations thereof applied to the word line 440.

Column decoder 614 may select one or more memory strings 210 in memory array 620 in response to the control of control logic circuit 611 and by applying a bit line 410 voltage generated from voltage generator 613.

The row decoder 615 may supply the word line 440 voltage generated from the voltage generator 613 to the selected word line and the unselected word line of the memory array 620 in response to the control of control logic circuit 611. As described in detail above, row decoder 615 is configured to perform program operations on memory cells 212 coupled to one or more selected word lines in memory array 620.

The page buffer 616 is coupled to the memory array 620 through bit lines 410. In some examples, the page buffer 616 may read data from and program (write) data to the memory array 620 according to control signals from the control logic circuit 611. In some other examples, the page buffer 616 may store program data (write data) to be programmed into the memory array 620. In yet other examples, the page buffer 616 may also perform a program verify operation to ensure that the data has been properly programmed into the memory cell 212 coupled to the selected word line.

The register 618 may be coupled to control logic circuit 611 and include status registers, command registers, and address registers for storing status information, command operation code, and command address for controlling the operation of each peripheral circuit 610.

It should be understood by those skilled in the art that the operations performed by the row decoder 615, the page buffer 616, the control logic circuit 611, and the voltage generator 613 described in the present disclosure may be performed by the processing circuit. The processing circuit may include, but is not limited to, hardware of a logic circuit or a hardware/software combination of a processor executing software.

In some examples, the memory device 120 is configured to be coupled to the memory controller 110, and the peripheral circuit 610 in the memory device 120 may receive a first write instruction sent by the memory controller 110, wherein the first write instruction includes a physical address of the first physical block. The peripheral circuit 610 may also apply various program voltages to the first physical block to program the memory cell in the first physical block to write M bits of data in response to the first write instruction. The first physical block is a physical block that passes a part of burn-in tests, and M is related to the part of burn-in tests passed by the first physical block.

Some examples of the present disclosure provide a computer-readable storage medium storing computer-executable instructions, wherein the computer-executable instructions, after executed, can implement the method according to any one of FIG. 5 to FIG. 9.

Some examples of the present disclosure provide a computer device, including a processor, and a readable storage medium coupled to the processor and storing executable instructions, wherein the executable instructions, when executed by a processor, can implement the method according to any one of FIG. 5 to FIG. 9.

Some examples of the present disclosure provide a memory system, a method of operating the memory system, a memory controller and a memory device. The memory device 120 may store a burn-in bad block table, and after obtaining the burn-in bad block table, the memory controller 110 may further subdivide the burn-in bad block according to the burn-in bad block table to determine the first physical block pool and the second physical block pool. When the number of free physical blocks 200 in the third physical block pool is small, the memory controller 110 may use the physical blocks 200 in the first physical block pool (e.g., select the first physical block) or the physical blocks 200 in the second physical block pool (e.g., select the second physical block) to store the data according to the memory mode. Thus, the subdivided physical block 200 that passes the part of burn-in tests may be used in a burn-in bad block that would not be otherwise used, to increase the number of valid physical blocks. The increase in the number of valid physical blocks increases the memory space of the memory system 100, thereby increasing the over provisioning, and improving the performance and lifetime of the memory system 100.

Those skilled in the art can clearly appreciate that, for ease and simplicity of description, in the above examples, the descriptions of various examples have their own emphases, and the portions of some example that are not described in detail may be referred to a corresponding process in the aforementioned method examples, which is no longer repeated herein.

In several examples provided by the present disclosure, it should be understood that the provided memory system, a method of operating the memory system, and a memory device may be implemented by other manners. For example, the division of some module is only a logical functional division and in a real implementation, there may be another manner for division. For example, a plurality of units or assemblies may be combined, or may be integrated into another system, or some features may be omitted or not performed.

Those of ordinary skill in the art can recognize that the modules and algorithm steps of various examples as described in conjunction with the examples disclosed herein can be implemented in an electronic hardware, or a combination of a computer software and an electronic hardware. Whether these functions are performed by means of a hardware or a software depends on particular applications and design constraints of the technical solutions. Professional technicians can implement the described function using different methods for each particular application, but such implementation should not be considered to be beyond the scope of the present disclosure.

According to a first aspect, some examples of the present disclosure provide a memory system. The memory system includes a memory device and a memory controller coupled to the memory device. The memory controller is configured to receive a first write request; and in response to the first write request, and send a first write instruction to the memory device. The first write instruction includes an address of a first physical block. The first write instruction instructs the memory device to program a memory cell in the first physical block to write M bits of data. The first physical block is a physical block that passes a part of burn-in tests. M is related to the part of burn-in tests passed by the first physical block.

In some examples, the memory controller is configured to send a first read instruction to the memory device in response to the memory device completing the program operation on the first physical block and perform error correction code decoding on data in the first physical block read by the memory device. The first read instruction includes an address of the first physical block, and the first read instruction instructs the memory device to perform a read operation on the first physical block.

In some examples, the memory controller is further configured to receive a second write request and send a second write instruction to the memory device in response to the second write request. The second write instruction includes an address of a second physical block. The second write instruction instructs the memory device to program a memory cell in the second physical block to write N bits of data. The second physical block is a physical block that passes a part of burn-in tests. N is related to the part of burn-in tests passed by the second physical block, and M is different from N.

In some examples, the memory controller is configured to send a second read instruction to the memory device in response to the memory device completing the program operation on the second physical block and perform error correction code decoding on data in the second physical block read by the memory device. The second read instruction includes an address of the second physical block, and the second read instruction instructs the memory device to perform a read operation on the second physical block.

In some examples, the memory controller is further configured to receive a third write request and in send a third write instruction to the memory device response to the third write request. The third write instruction includes an address of a third physical block, and the third write instruction instructs the memory device to program a memory cell in the third physical block to write data. The third physical block is a physical block that passes all burn-in tests.

In some examples, the first physical block belongs to a first physical block pool, the second physical block belongs to a second physical block pool, and the third physical block belongs to a third physical block pool. The memory controller is further configured to obtain burn-in test results of the memory device and determine the first physical block pool, the second physical block pool, and the third physical block pool according to the burn-in test results.

In some examples, the burn-in test results are stored in the memory device.

In some examples, the burn-in test includes a first memory mode test and a second memory mode test. A memory cell in a physical block that passes the first memory mode test supports storing M bits of data, and a memory cell in a physical block that passes the second memory mode test supports storing N bits of data. A physical block in the first physical block pool is a physical block that passes the first memory mode test but fails the second memory mode test. A physical block in the second physical block pool is a physical block that passes the second memory mode test but fails the first memory mode test. A physical block in the third physical block pool is a physical block that passes the first memory mode test and passes the second memory mode test.

In some examples, the memory controller is configured to: receive and in response to a write request, send a third write instruction to the memory device when a number of free physical blocks in the third physical block pool is greater than a preset number; and when the number of free physical blocks in the third physical block pool is less than or equal to the preset number, in response to writing the data in a first memory mode, send a first write instruction to the memory device; and in response to writing the data in a second memory mode, send a second write instruction to the memory device.

In some examples, the preset number is equal to zero.

In some examples, the first physical block and the second physical block include a physical block marked as a bad block.

According to a second aspect, some examples of the present disclosure provide a method of operating a memory system. The method includes: receiving and responding to, by a memory controller, a first write request, sending a first write instruction to a memory device, wherein the first write instruction includes an address of a first physical block, the first write instruction instructs the memory device to program a memory cell in the first physical block to write M bits of data, wherein the first physical block is a physical block that passes a part of burn-in tests, and M is related to the part of burn-in tests passed by the first physical block.

In some examples, the method further includes: in response to the memory device completing the program operation on the first physical block, sending, by the memory controller, a first read instruction to the memory device, wherein the first read instruction includes an address of the first physical block, and the first read instruction instructs the memory device to perform a read operation on the first physical block; and performing, by the memory controller, error correction code decoding on data in the first physical block read by the memory device.

In some examples, the method further includes: receiving and responding to, by the memory controller, a second write request, sending a second write instruction to the memory device, wherein the second write instruction includes an address of a second physical block, the second write instruction instructs the memory device to program a memory cell in the second physical block to write N bits of data, wherein the second physical block is a physical block that passes a part of burn-in tests, N is related to the part of burn-in tests passed by the second physical block, and M is different from N.

In some examples, the method further includes: in response to the memory device completing the program operation on the second physical block, sending, by the memory controller, a second read instruction to the memory device, wherein the second read instruction includes an address of the second physical block, and the second read instruction instructs the memory device to perform a read operation on the second physical block; and performing, by the memory controller, error correction code decoding on data in the second physical block read by the memory device.

In some examples, the method further includes: receiving and responding to, by the memory controller, a third write request, sending a third write instruction to the memory device, wherein the third write instruction includes an address of a third physical block, and the third write instruction instructs the memory device to program a memory cell in the third physical block to write data, wherein the third physical block is a physical block that passes all burn-in tests.

In some examples, the first physical block belongs to a first physical block pool, the second physical block belongs to a second physical block pool, and the third physical block belongs to a third physical block pool. The method further includes: obtaining, by the memory controller, burn-in test results of the memory device; and determining, by the memory controller, the first physical block pool, the second physical block pool, and the third physical block pool according to the burn-in test results.

In some examples, the burn-in test results are stored in the memory device.

In some examples, the burn-in test includes a first memory mode test and a second memory mode test, a memory cell in a physical block that passes the first memory mode test supports storing M bits of data, and a memory cell in a physical block that passes the second memory mode test supports storing N bits of data. A physical block in the first physical block pool is a physical block that passes the first memory mode test but fails the second memory mode test. A physical block in the second physical block pool is a physical block that passes the second memory mode test but fails the first memory mode test. A physical block in the third physical block pool is a physical block that passes the first memory mode test and passes the second memory mode test.

In some examples, the method further includes: receiving and responding to, by the memory controller, a write request, when a number of free physical blocks in the third physical block pool is greater than a preset number, sending a third write instruction to the memory device; and when the number of free physical blocks in the third physical block pool is less than or equal to the preset number, in response to writing the data in a first memory mode, sending a first write instruction to the memory device; and in response to writing the data in a second memory mode, sending a second write instruction to the memory device.

In some examples, the preset number is equal to zero.

In some examples, the first physical block and the second physical block include a physical block marked as a bad block.

According to a third aspect, some examples of the present disclosure provide a memory controller. The memory controller includes a processing circuit, a first interface circuit and a second interface circuit, wherein the first interface circuit and the second interface circuit are respectively coupled to the processing circuit. The processing circuit is configured to: receive a first write request through the first interface circuit; and in response to the first write request, send a first write instruction to a memory device through the second interface circuit, wherein the first write instruction includes an address of a first physical block. The first write instruction instructs the memory device to program a memory cell in the first physical block to write M bits of data, wherein the first physical block is a physical block that passes a part of burn-in tests, and M is related to the part of burn-in tests passed by the first physical block.

According to a fourth aspect, some examples of the present disclosure provide a memory device. The memory device is configured to be coupled to a memory controller, wherein the memory device is configured to: receive a first write instruction, wherein the first write instruction includes an address of a first physical block; and in response to the first write instruction, program a memory cell in the first physical block to write M bits of data, wherein the first physical block is a physical block that passes a part of burn-in tests, and M is related to the part of burn-in tests passed by the first physical block.

According to a fifth aspect, some examples of the present disclosure provide a computer-readable storage medium storing computer-executable instructions, wherein the computer-executable instructions, after executed, implement the method according to the second aspect.

According to a sixth aspect, some examples of the present disclosure provide a computer device, including a processor, and a readable storage medium coupled to the processor and storing executable instructions, wherein the executable instructions, when executed by a processor, implement the method according to the second aspect.

The above descriptions are merely specific examples of the present disclosure, and the protection scope of the present disclosure is not limited to these. Any variation or replacement that may be readily figured out by those skilled in the art within the technical scope disclosed by the present disclosure shall fall within the protection scope of the present disclosure. Therefore, the protection scope of the present disclosure shall be defined by the protection scope of the claims.

What is claimed is:

1. A memory system, comprising:
a memory device; and
a memory controller coupled to the memory device and configured to:
receive a first write request; and
in response to the first write request, send a first write instruction to the memory device, wherein the first write instruction comprises an address of a first physical block, the first write instruction to instruct the memory device to program a memory cell in the first physical block to write M bits of data,
wherein the first physical block passes a part of burn-in tests, and M is related to the part of the burn-in tests passed by the first physical block.

2. The memory system of claim 1, wherein the memory controller is configured to:
in response to the memory device completing a program operation on the first physical block, send a first read instruction to the memory device, wherein the first read instruction comprises an address of the first physical block, and the first read instruction is to instruct the memory device to perform a read operation on the first physical block; and
perform error correction code decoding on data in the first physical block read by the memory device.

3. The memory system of claim 1, wherein the memory cell is a first physical memory cell, the memory controller is configured to:
receive a second write request; and
in response to the second write request, send a second write instruction to the memory device, wherein the second write instruction comprises an address of a second physical block, and the second write instruction instructs the memory device to program a second memory cell in the second physical block to write N bits of data,
wherein the second physical block passes a second part of the burn-in tests, N is related to the second part of the burn-in tests passed by the second physical block, and M is different from N.

4. The memory system of claim 3, wherein the memory controller is configured to:
in response to the memory device completing a program operation on the second physical block, send a second read instruction to the memory device, wherein the second read instruction comprises an address of the second physical block, and the second read instruction is to instruct the memory device to perform a read operation on the second physical block; and
perform error correction code decoding on data in the second physical block read by the memory device.

5. The memory system of claim 3, wherein the memory controller is configured to:
receive a third write request; and
in response to the third write request, send a third write instruction to the memory device, wherein the third write instruction comprises an address of a third physical block, and the third write instruction is to instruct the memory device to program a third memory cell in the third physical block to write data,
wherein the third physical block passes all the burn-in tests.

6. The memory system of claim 5, wherein the first physical block belongs to a first physical block pool, the second physical block belongs to a second physical block pool, and the third physical block belongs to a third physical block pool, and the memory controller is configured to:
obtain burn-in test results of the memory device; and
determine the first physical block pool, the second physical block pool, and the third physical block pool according to the burn-in test results.

7. The memory system of claim 6, wherein the burn-in test results are stored in the memory device.

8. The memory system of claim 6, wherein:
the burn-in tests comprise a first memory mode test and a second memory mode test, a fourth memory cell in a fourth physical block that passes the first memory mode test supports storing M bits of data, and a fifth memory cell in a fifth physical block that passes the second memory mode test supports storing N bits of data,
a sixth physical block in the first physical block pool passes the first memory mode test but fails the second memory mode test,
a seventh physical block in the second physical block pool passes the second memory mode test but fails the first memory mode test, and
an eighth physical block in the third physical block pool passes the first memory mode test and passes the second memory mode test.

9. The memory system of claim 6, wherein the memory controller is configured to:
when a number of free physical blocks in the third physical block pool is greater than a preset number, send the third write instruction to the memory device; and
when the number of free physical blocks in the third physical block pool is less than or equal to the preset number, and in response to writing data in a first memory mode, send the first write instruction to the memory device; and
in response to writing data in a second memory mode, send the second write instruction to the memory device.

10. The memory system of claim 9, wherein the preset number is equal to zero.

11. The memory system of claim 6, wherein the first physical block and the second physical block comprise a physical block marked as a bad block.

12. A method of operating a memory system, comprising:
receiving and responding, by a memory controller, to a first write request; and
sending a first write instruction to a memory device, wherein the first write instruction comprises an address of a first physical block, the first write instruction instructs the memory device to program a memory cell in the first physical block to write M bits of data,
wherein the first physical block passes a part of burn-in tests, and M is related to the part of the burn-in tests passed by the first physical block.

13. The method of claim 12, further comprising:
in response to the memory device completing a program operation on the first physical block, sending, by the memory controller, a first read instruction to the memory device, wherein the first read instruction comprises an address of the first physical block, and the first read instruction instructs the memory device to perform a read operation on the first physical block; and
performing error correction code decoding on data in the first physical block read by the memory device.

14. The method of claim 12, wherein the memory cell is a first memory cell, further comprising:
receiving and responding, by the memory controller, to a second write request; and
sending a second write instruction to the memory device, wherein the second write instruction comprises an address of a second physical block, the second write instruction instructs the memory device to program a second memory cell in the second physical block to write N bits of data,
wherein the second physical block passes a second part of the burn-in tests, N is related to the second part of the burn-in tests passed by the second physical block, and M is different from N.

15. The method of claim 14, further comprising:
in response to the memory device completing a program operation on the second physical block, sending, by the memory controller, a second read instruction to the memory device, wherein the second read instruction comprises an address of the second physical block, and the second read instruction instructs the memory device to perform a read operation on the second physical block; and
performing error correction code decoding on data in the second physical block read by the memory device.

16. The method of claim 14, further comprising:
receiving and responding, by the memory controller, to a third write request; and
sending a third write instruction to the memory device, wherein the third write instruction comprises an address of a third physical block, and the third write instruction instructs the memory device to program a third memory cell in the third physical block to write data,
wherein the third physical block is a physical block that passes all the burn-in tests.

17. The method of claim 16, wherein the first physical block belongs to a first physical block pool, the second physical block belongs to a second physical block pool, and the third physical block belongs to a third physical block pool, and the method further comprises:
obtaining, by the memory controller, burn-in test results of the memory device; and
determining the first physical block pool, the second physical block pool, and the third physical block pool according to the burn-in test results.

18. The method of claim 17, wherein:
the burn-in tests comprise a first memory mode test and a second memory mode test, a fourth memory cell in a fourth physical block that passes the first memory mode test supports storing M bits of data, and a fifth memory cell in a fifth physical block that passes the second memory mode test supports storing N bits of data,
a sixth physical block in the first physical block pool passes the first memory mode test but fails the second memory mode test,
a seventh physical block in the second physical block pool passes the second memory mode test but fails the first memory mode test, and
an eighth physical block in the third physical block pool passes the first memory mode test and passes the second memory mode test.

19. The method of claim 17, further comprising:
when a number of free physical blocks in the third physical block pool is greater than a preset number, sending the third write instruction to the memory device;
when the number of free physical blocks in the third physical block pool is less than or equal to the preset number, and in response to writing data in a first memory mode, sending the first write instruction to the memory device; and
in response to writing data in a second memory mode, sending the second write instruction to the memory device.

20. A memory controller, comprising:
a processor circuit,
a first interface circuit coupled to the processor circuit; and
a second interface circuit coupled to the processor circuit,
the processor circuit is configured to:
receive a first write request through the first interface circuit; and
in response to the first write request, send a first write instruction to a memory device through the second interface circuit, wherein the first write instruction comprises an address of a first physical block, the first write instruction to instruct the memory device to program a memory cell in the first physical block to write M bits of data,
wherein the first physical block passes a part of burn-in tests, and M is related to the part of the burn-in tests passed by the first physical block.
